(19) United States
(12) Patent Application Publication
(10) Pub. No.: US 2025/0224950 A1
(43) Pub. Date: Jul. 10, 2025

(54) MANAGEMENT AND UPDATING SYSTEM FOR AUTOMATION DEVICES OF AN AUTOMATION SYSTEM CONNECTED TO AN OT NETWORK

(71) Applicant: Phoenix Contact GmbH & Co. KG, Blomberg (DE)

(72) Inventors: Arno Martin FAST, Lage (DE); Boris WALDECK, Hiddenhausen (DE); Friedrich WEGENER, Vahlbruch (DE)

(21) Appl. No.: 18/849,967

(22) PCT Filed: Mar. 23, 2023
(86) PCT No.: PCT/EP2023/057462

§ 371 Date: Sep. 23, 2024

(30) Foreign Application Priority Data
Mar. 24, 2022 (LU) LU501705

(51) Int. Cl. G06F 8/65; G05B 13/02

(52) U.S. Cl. CPC G06F 8/65; G05B 13/0205

(57) ABSTRACT

A management and updating system for automation devices connected to an OT network of an automation plant, includes a device management and updating user unit programmed to provide a service for providing a communications interface for producing a communication link with connected ones of the automation devices, a read-out service for reading-out device-type information stored in each automation device, and for storing read-out device-type information, a service for planning update requests for each automation device having saved read-out device-type information, a service for communicating with at least one memory unit and retrieving update files stored therein, a service for checking each retrieved update file for its release relative to the automation devices in functional dependency on the stored device-type information, and, if the checking of one of the retrieved update files leads to a release for an automation device, for allocating this update file to the device-type information saved for this automation device, and a service for transmitting according to saved device-type information to each automation device of the update file allocated thereto, along with an update command, and functionally dependent on the update requests planned for each automation device.

### FIELD

The invention relates to a system for managing and updating automation devices connected to an OT network of an automation plant.

### BACKGROUND

Traditionally, an update for automation devices connected to an OT network of an automation plant, hereinafter also referred to as industrial automation devices, in particular the firmware on these devices, is only possible locally and individually for each device. Different tools are therefore used for many devices. New developments for individual devices are planned or have already been launched. However, to the best of our knowledge, no or only device-specific standards are currently in use.

There are so-called “device management tools” for managing industrial automation devices, such as the tool for device-specific network configuration and -monitoring marketed by the company Etherwan under the name “eVue”, the software marketed by the company Perle under the name “PerleView” for their network components, or the “Mobile Device Management” from the company Phoenix Contact Cyber Security GmbH for updating their “MGuard” devices for remote maintenance and monitoring via mobile networks.

Based on such “device management tools”, however, there are further requirements, particularly with regard to a comprehensive and modular device management system while at the same time guaranteeing end-to-end security (in English “Security”).

Requirements regarding the closing of security gaps or the expansion of functions have long been known for computers, the IT infrastructure or even mobile terminal devices. For automation devices such as a PLC (programmable logic controller) or network components in a plant, these requirements have not been an issue for so long and the closer IT and OT come to each other, i.e. the “information technology” (IT) describing/concerning electronic data processing and the “operational technology” (OT), which concerns the hardware and software infrastructure for direct monitoring and/or control of industrial plants, devices, processes and events, the more a device and update management, i.e. “device and update management”, is required for the automation market. The internationally standardized ISA95 model, which divides automation into five levels, serves to differentiate between IT and OT in the context of the invention. The top two levels comprise the superordinate company level and the operations management level. The digital processes at these levels are assigned to IT and take place in IT networks set up for this purpose. The automation processes at the lower three levels, i.e. the process management level, the control level and the field level, are controlled via appropriately set up OT networks. A link is therefore always required for a connection, including data exchange, between the two networks.

DE 10 2006 010 539 A1, for example, describes a regular update of a user profile of a program-controlled device and, depending on this, the update of a program of this device.

EP 3 764 221 A1, for example, describes an updating of a software version of an application on an automation device, wherein an updated version is first executed in a secured area of a data processing device with historical process data for generating test correction data and the test correction data is compared with correction data generated by the application of the automation device from the historical process data before an exchange with the updated version of the application takes place.

DE 10 2015 112 040 A1, for example, describes a firmware updating of a control device for process control, whereby a device-specific authorization check is carried out by the manufacturer and, based on this, a device-specific activation code is provided for carrying out the firmware updating by means of an update device that can be connected to the control device on the user side.

EP 3 001 310 A1, for example, describes an updating of firmware for components of an industrial automation arrangement, whereby the components to be updated and the firmware versions that can be used for the update are determined on the basis of stored compatibility relationships between different firmware versions available for the components and stored information about the firmware versions currently used in the components.

EP 3 588 277 A1, for example, describes a firmware updating in which a firmware package is compiled for a device complex with at least one hierarchically higher and at least one hierarchically lower device and is distributed and applied in a top-down sequence, starting with a transmission to the hierarchically higher device. It is essential that the firmware package compiled for the device complex is transmitted to a single device within the complex, which then coordinates further distribution.

EP 3 696 699 A1, for example, describes a firmware updating in an electronic device in which, after receipt of an update file comprising a new firmware, a signature and a certificate with verification information, this verification information is first compared with verification information read out from the electronic device, and only as a function of the comparison is the signature then checked, if necessary, and finally the actual update is carried out as a function of this.

WO 2016/092003 A1 (EP3230856), for example, describes a firmware updating of devices in which a firmware file is transferred from a loading tool to the device, taking into account firmware-specific and/or device-specific loading information. In order to enable the firmware update of different devices with only one loading tool, it is intended that the loading information is stored separately from the loading tool on at least one external data source and loaded by the loading tool.

US 2018/0357058 A1, for example, describes a firmware updating in which available firmware updates are determined by a product compatibility and download center based on a configuration template and, depending on this, required firmware update files and a firmware update schedule are automatically determined, whereby the required firmware update files are transferred to the industrial components in a sequence determined by the firmware update schedule.

US 2018/0359144 A1, for example, describes a firmware updating in a similar manner to the latter document, but in which a firmware update menu is provided by an update server to a user via a web interface within an application running on a user unit and a selection made by the user is received via the web interface, wherein required firmware update files and a firmware update schedule are determined based thereon and the required firmware update files are transmitted to the industrial components in a sequence determined by the firmware update schedule.

EP 2 189 900 A1, for example, describes a software updating in which an update applicable to a configuration of nodes of a process control system is identified, update software and associated metadata concerning the applicability of the software to a node are provided and, on the basis of the metadata, installation of the software for updating is carried out from a workstation communicating with the node of the process control system.

DE 102 40 584 A1, for example, describes an installation of a new operating program for a safety controller, in which a download device for accepting a new operating program is provided in the safety controller, which enables or prevents the acceptance of the new operating program in a fail-safe manner depending on release information.

EP 3 923 095 A1, for example describes a software updating of a technical system, in which configuration parameters comprising operating parameters of a production process of a technical system are recorded and software updates for an element of the technical system are loaded, wherein an update configuration for the software update of the element is determined on the basis of the operating parameters and the software updates, and the update configuration and/or the software update is transmitted to an update server, wherein the update server controls and/or monitors and/or records the software update of the element of the technical system on the basis of the update configuration.

Against the background of the state of the art described above, it is the task of the invention to demonstrate a new way, in particular also for manufacturer-independent management and updating of industrial automation devices of an automation plant, such as, for example of programmable logic controllers, IO modules (input/output modules), frequency converters, robots, network devices, power supplies or other components used in automation technology, whereby not only the possibility of cross-component updating, but also consistent security at all levels of an automation system should be provided.

### SUMMARY

The solution according to the invention is provided by a system with the features of claim 1 and a data storage medium according to claim 10. Useful embodiments of the invention are the subject of the dependent claims.

Accordingly, the invention proposes a management and updating system for automation devices connected to an OT network of an automation plant, the management and updating system comprising a device management and updating user unit connected to an OT network to which a plurality of automation devices of an automation plant are further connected. The device management and update user unit is furthermore set up by programming to provide:
an interface selection and connection service set up to select and set up a communication interface for establishing a communication link to an automation device of the plurality of connected automation devices,
a read-out service, set up for activating a read-out from each automation device to which the communication link is established, of device type information stored in the automation device, and for saving the device type information read out in each case,
an update planning service set up to plan update requests for each automation device of the plurality of automation devices for which read-out device type information is saved,
an update file retrieval service set up to establish a communication link to at least one storage device and retrieve update files stored in the storage device,
a check and allocation service set up to check each retrieved update file for its release with respect to the plurality of automation devices in functional dependence on the stored device type information and, if the check of one of the retrieved update files results in a release for an automation device, to allocate this update file to the device type information stored for this automation device,
an update service set up to transmit according to saved device-type information to each automation device the respective update file allocated to that automation device, along with an update command, and functionally dependent on the update requests planned for each automation device.

Significant advantages of the invention with regard to the aforementioned prior art can therefore be seen in the fact that with the device management and update user unit set up according to the invention, which is connected to the same OT network in addition to the plurality of automation devices of an automation system, a central device management and update component is created, in particular using hardware and software components, with which updates of the individual automation devices can be centrally controlled by means of definable update plans, preferably by a respective user. This centrally created device management and update component can also be used to simultaneously check whether an update is suitable for a particular automation device. Furthermore, the centrally created device management and update component thus enables the respective update to be carried out in relation to an individual automation device, which offers a high degree of flexibility. This also allows favorably, in particular by means of the update planning service, to specify with the device management and update user unit for each individual automation device the sequence and version of updates, such as software to be updated, centrally but individually.

In addition, a description file can preferably be assigned to each update file, e.g. a firmware, for carrying out a check of each retrieved update file for its release. Consequently, in addition to the stored information read out from the automation devices, the respective description file can also be used in the centrally created device management and update component when checking whether an update should be carried out, so that the compatibility between the automation device and its update or the update file can be ensured to the highest degree. If a signature is contained in the update files in an appropriate manner, the authenticity and consequently the authenticity of the update file itself can be checked preferably using public keys that can be stored or have already been stored in a memory of the centrally created device management and update component.

The invention further provides for the provision of a data storage medium with a program code stored thereon, which is designed such that a data processing device connectable to an OT network, when programmed with the program code, provides a device management and update user unit set up accordingly.

### BRIEF DESCRIPTION OF THE DRAWINGS

The features and advantages of the invention already outlined above as well as further features and advantages of the invention are shown in more detail in the following description by means of examples of preferred embodiments and variation, reference being made to the accompanying drawings, which show:

FIG. 1 an overview of a device management and updating user unit integrated into an exemplary management and updating system for automation devices connected to an OT network of an automation plant according to the invention,

FIG. 2 an exemplary user interface for device and update management on a device management and update user unit set up according to the invention with an operating screen open for the overview of definable or already defined update storage locations,

FIG. 3 the exemplary user interface as shown in FIG. 2 with an operating screen open for the display/selection of imported update files,

FIG. 4 the exemplary user interface according to FIG. 2 with an operating screen opened for the release of update files according to FIG. 3,

FIG. 5 an exemplary overview of communication links possible by means of the device management and updating user unit according to the invention,

FIG. 6 the exemplary user interface according to FIG. 2 with an operating screen open for specifying communication interfaces and communication links,

FIG. 7 the exemplary user interface according to FIG. 2 with an open operating screen for displaying and organizing assets contained in a respective automation device,

FIG. 8 the exemplary user interface according to FIG. 2 with an operating screen opened to create an update plan,

FIG. 9 the example user interface as shown in FIG. 2 with an operating screen opened after starting an update plan,

FIG. 10 the exemplary user interface according to FIG. 2 with an operating screen opened to log an update,

FIG. 11 an overview of an exemplary overall architecture of a management and updating system according to the invention, and

FIG. 12 an overview of an exemplary superimposed management platform for a plurality of device management and updating user units in the context of a management and updating system according to the invention.

### DETAILED DESCRIPTION

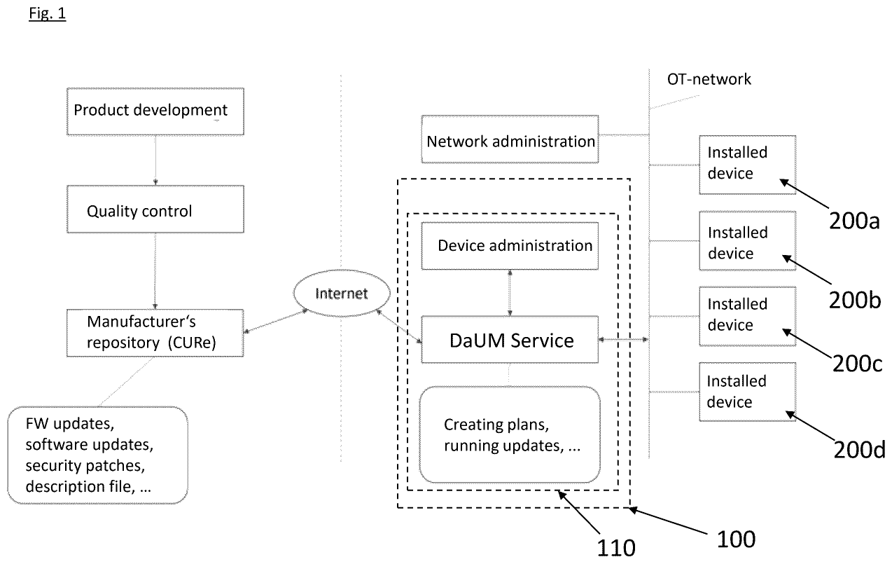

In the following, reference is made to FIGS. 1 to 12, on the basis of which examples of preferred embodiments and variations of a management and updating system according to the invention are outlined and shown in a highly simplified form for reasons of clarity.

FIG. 1 shows an exemplary embodiment of the invention for automation devices 200a-200d connected to an OT network of an automation plant.

A management and update system 100 not shown in detail in FIG. 1 for reasons of clarity, hereinafter also referred to as DaUM system (“Device and Update Management System”), comprises or integrates in particular a device management and update user unit 110, which is connected to an OT network, to which furthermore the plurality of automation devices 200a-200d of the automation plant is connected and thus installed there. As will be explained in more detail below, the device management and update user unit 110 is also set up by programming to provide various services. In FIG. 1, these services of the management and update system are referred to in their entirety as DaUM Service (“Device and Update Management Service”) and ensure in their entirety in the context of management and updating in particular a dynamic monitoring of assets and functions of the automation devices installed to the OT network.

It should be noted that in the context of the invention, assets generally include any type of hardware (e.g. servers and switches) and software (e.g. firmware, applications, configurations and supporting systems) of an automation environment that supports activities in the context of an automation plant with automation devices connected to an OT network. This generally also includes confidential information that must be protected against unlawful access or unlawful use, disclosure, modification, destruction and/or theft.

Assuming, for example, that new files are to be created for updating the automation devices 200a-200d shown in FIG. 1, which are connected to the OT network and installed, and that the automation devices 200a-200d are then to be updated with the files, typically, depending on the manufacturer, corresponding firmware and software modules are initially provided by the manufacturer as files via the product development with the associated quality assurance and stored or temporarily stored in a storage device. In particular, the storage device can also be a storage device of the manufacturer, but within the scope of the invention, it can in principle comprise any type of storage device, such as a USB stick or a storage space that can be accessed via the Internet. In particular, the storage device thus essentially represents a central update repository as a source that is provided in relation to these files and intended for updating, which is also referred to as “Cure” (“Central Update Repository” in FIG. 1 and below.

Consequently, in the context of the invention, the device management and update user unit 110 is initially set up by programming for providing an update file retrieval service, i.e. in particular for setting up a communication link to at least one storage device and for retrieving update files stored in the storage device.

In order to use a storage device that is accessible via the Internet, e.g. as outlined in FIG. 1, for example in the form of a CURe server, the device management and update user unit 110 is therefore appropriately set up by programming in such a way that a defined interface to the Cure can be set up via the Internet and the update files stored there can then be retrieved from the CURe via the DaUM system 100. These retrieved update files can then be conveniently stored and/or further processed locally in an own data repository, not shown in FIG. 1 for reasons of clarity, hereinafter also referred to as LR (“local repository”), of the DaUM system 100. Such further processing also includes, in particular, the creation of own, locally managed actualization or update repositories, which expediently only contain released updates.

On the other hand, via the device management and update user unit 110 set up by programming an interface selection and connection service is provided for selecting and setting up a communication interface and for establishing a communication link to an, i.e. in particular to at least one and preferably to each automation device of the plurality of connected automation devices 200a-200d. The installed devices, i.e. the automation devices 200a-200d, are thus expediently preset by a network administration beforehand, e.g. with a corresponding IP address and the necessary network settings, in such a way that they can then also be reached via the communication link of the DaUM system 100 established via the communication interface set up.

According to the invention, it is further provided that, by means of a read-out service provided via the device management and updating user unit 110 set up by programming, after corresponding activation, from each automation device to which the communication link has been established the device type information stored therein is then read out and saved by the DaUM system 100. Conveniently, also the device type information can thus be saved in the aforementioned own data repository.

By means of an update planning service also provided via the device management and update user unit 110 set up by programming, the update planning service being set up for planning update requests for each automation device of the plurality of automation devices for which read-out device type information is stored, an actualization or update plan can be created by the user/operator, in particular by persons of the device administration, by means of the DaUM system via an operating mask of the device management and update user unit 110 with the data contained in the aforementioned own data storage, in order to supply each automation device to be updated, in particular also in relation to specific assets of a respective automation device, with new versions of firmware or other software.

In particular since, as already shown above, further processing of update files and thus also for supplying the automation devices with update files should only concern released update files or updates, a check and allocation service is also provided via the device management and update user unit 110 set up by programming, which is set up to check each retrieved update file for its release in relation to the plurality of automation devices in functional dependence on the stored device type information and, if the check of one of the retrieved update files leads to a release for an automation device, to allocate this update file to the device type information saved for this automation device. In addition, the device management and update user unit is appropriately set up by programming to also save allocated update files, in particular in the aforementioned own data storage.

An update service provided via the device management and update user unit 110 set up by programming is then ultimately set up to transmit to each automation device the update file allocated to it in each case according to saved device type information, including an update command, in each case in functional dependence on the update requests planned for each automation device.

In addition, the device management and update user unit is appropriately set up by programming to log the respective update status in relation to each automation device for which read-out device type information is saved.

The management and updating system according to the invention, also referred to as DaUM system in the context of the invention, is consequently designed and set up in a generalized manner to provide or perform essentially the following functions:
a function for retrieving files for updating, in particular stored by the respective manufacturers of automation devices connected to an OT network;
a function for setting up and managing the communication interfaces to the automation devices connected to the OT network;
a function for managing and releasing software files that are to be distributed to the connected automation devices;
a function for reading current device type information;
a function for planning updates, in particular including checking and allocating files to specific devices with termination conditions and start times;
a function for carrying out the updates on the devices, i.e. in particular downloading and starting the update process; and expediently
a function for logging all events.

With regard to the update file retrieval service provided via the device management and update user unit 110 set up by programming, and thus in particular with regard to the function of retrieving files for updating to be provided or executed, several different storage devices can thus be defined in practical implementation as sources, hereinafter referred to as “cure” (“central update repositories”), from which the DaUM system is to obtain the update files. As the update files are conveniently available or transferred as update data packages in practical implementation, the update files are also referred to below as update packages. These are typically services provided by the device manufacturers for automatic access to actualizations or updates or the user's own data storage systems, e.g. also via the Internet. However, it is also possible to make the update packages available to the DaUM system locally via a mass storage medium, e.g. a USB stick or file transfer.

An update file, i.e. in particular an update data package (“update package”), preferably consists of a description file, the actual update file and accompanying documents.

In the event that the DaUM system is thus connected to a CURe after setting up a communication link, expediently via a user interface of the device management and update user unit 110, the DaUM system preferably automatically, e.g. also cyclically, queries whether there is a new version of a description file for a specific automation device, in particular for an asset that is included in this. In particular, the description file is then downloaded first and can be evaluated in the DaUM system. This can also be conveniently displayed to the user/operator via a correspondingly adapted operating view.

This description file contains at least information on the file type, the update file, manufacturer information, version information, type information, dependencies on existing previous versions and/or hardware versions, a unique ID (identification code), checksum, release status and/or other accompanying documents, such as license information, modification notes (“change notes), version notes (“release notes”). Optionally, further information can of course be provided, such as the duration of a typical update process. The user/operator can then conveniently select the desired files from the description file via a user interface and the DaUM system then downloads the included or preferably only selected files as an update package from the cure.

If the description file or each description file is also appropriately provided with a cryptographic signature by the manufacturer, the DaUM system can check this signature to ensure that the file has not been modified by a potential attacker. For this purpose, in particular a number of public keys can be stored or have already been stored in a memory of the device management and update user unit 110 and the check and allocation service service provided uses this number of public keys to verify the signatures contained in the retrieved update files, which have been created accordingly with a private key.

In particular, based on XAdES (“XML Advanced Electronic Signatures”), which is known to be a set of extensions for the W3C recommendation XML-DSig, which enables the use of advanced electronic signatures and specifies precise profiles for XML-DSig for use with authorized electronic signatures in the meaning of EU Directive 1999/93/EC valid at the time of the present application, whereby an important factor of XAdES is that electronically signed documents remain valid for a long time, even if the underlying cryptographic algorithms have been cracked, the DaUM system can, on the one hand, expediently check only the signature itself (XAdES-B level) without checking the extensions of the signature. Alternatively, however, the DaUM system can also support verification of the signature with the extensions according to XAdES level LT or LTA.

In particular, however, the description file is checked in the DaUM system before the relevant data is used further.

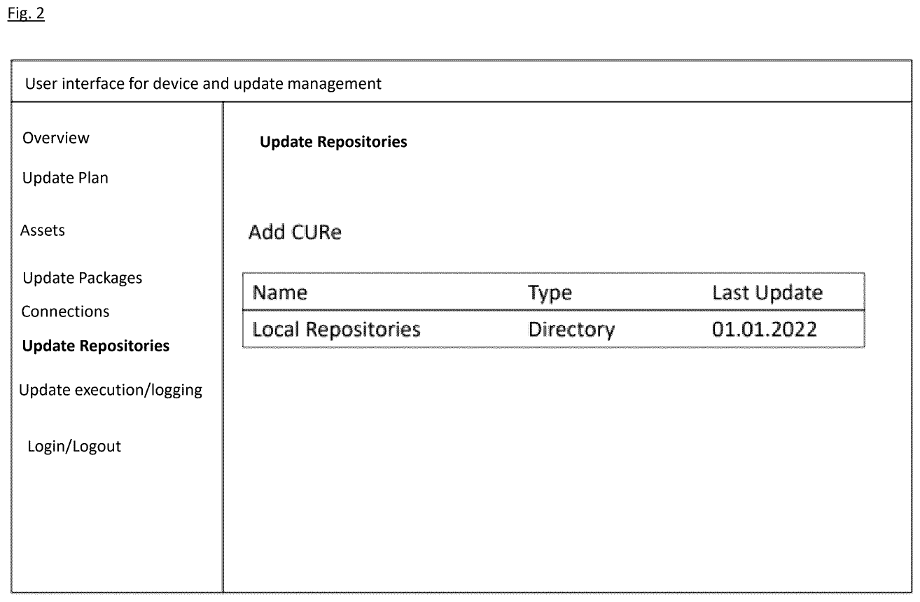

All update packages supplied to the DaUM system are conveniently stored in the DaUM system in a local data storage (LR—“Local Repository”) and can be reused from there. FIG. 2 shows an exemplary user interface for device and update management on a device management and update user unit 110 set up according to the invention with an overview of definable or already defined update storage locations, for example also concerning a local data storage “Local Repositories” as data source “Cure”. The advantage of using an LR as a cure is that no active connection to a CURe, whether via a USB stick or the Internet, is required during an update of an automation device, in particular an asset that is included in this.

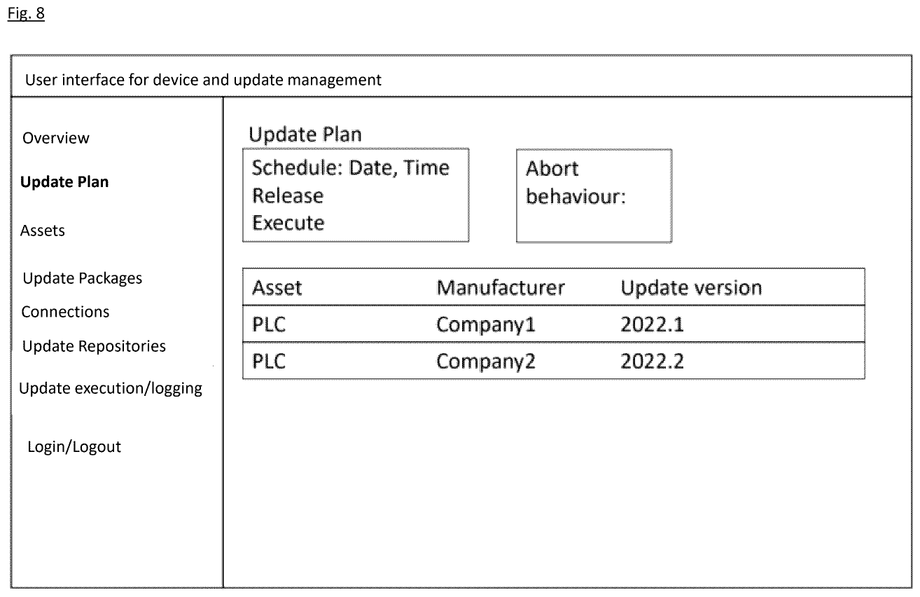

As already mentioned above, the update file retrieval service of the DaUM system can preferably be set up to automatically check independently, appropriately in regular, adjustable cycles, whether there is a new, compatible update package on the central source, i.e. the cure, for at least one of the automation devices managed via the DaUM system, which is thus set up quasi as an intermediate component, and can then, for example, also send a message to the user/operator or display it to the user/operator via the correspondingly adapted operating view. This message or display can then also inform the user/operator whether it is a critical security update, for example, which should be installed urgently, or also indicate that there is a new update package for already planned updating plans (see also FIG. 8).

In particular by means of the checking and allocating service provided via the device management and update user unit 110 set up by programming, in particular with regard to the function of managing and releasing software files which are to be distributed to the connected automation devices, in particular to the assets, the downloaded files belonging together, i.e. the files from the entirety of the description file, update file and accompanying documents belonging to an update package, can thus be summarized again, preferably first as an update package, in further and for further processing, before they are stored or temporarily stored in an own, local data storage for further processing. As already shown above, the DaUM system thus preferably also receives additional accompanying documents in addition to the pure update files, such as the above-mentioned change notes, license conditions, etc., which are also conveniently listed individually in the associated description files.

Furthermore, it is expedient, in particular for reasons of security, that the release of the retrieved update files for an automation device after an appropriate check must be explicitly released for further processing or use by an authorized user/operator with the authorization to release updates for further use in the DaUM system, i.e. must be confirmed in particular via the user interface, so that the update package cannot be used by any other user in particular without corresponding explicit release.

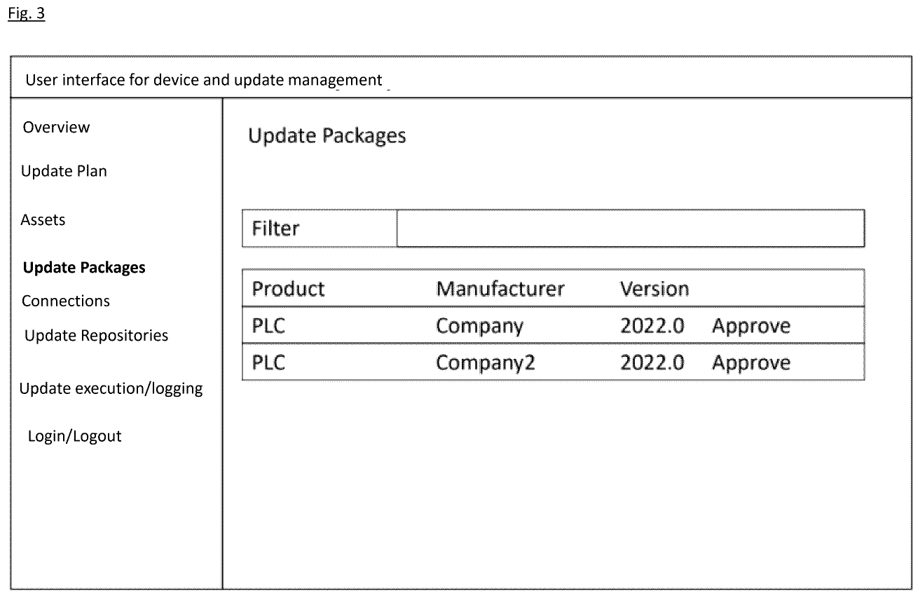

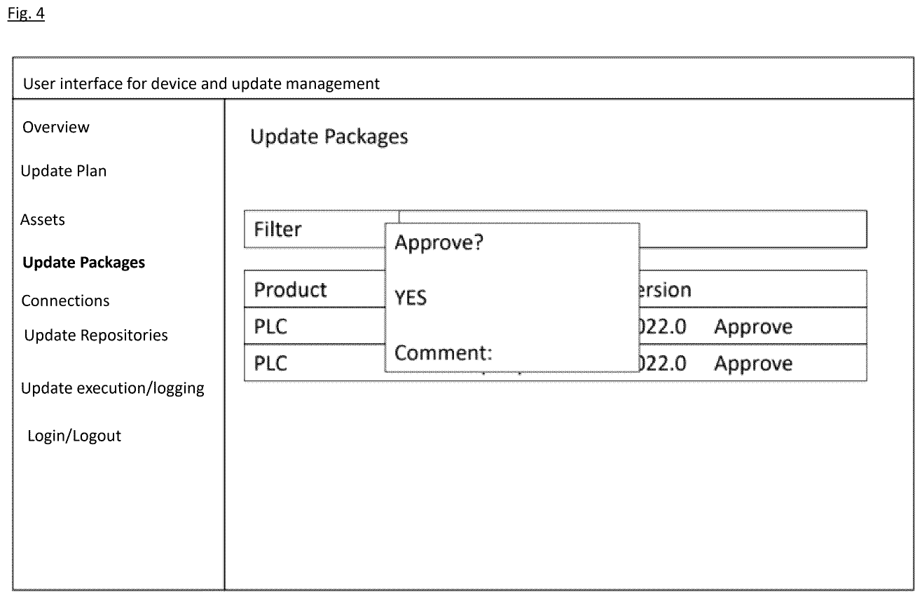

FIG. 3 shows the exemplary user interface with an operating screen open for the display/selection of imported or downloaded update files or update packages and FIG. 4 shows the exemplary user interface with an operating screen open for the explicit release (“Approve”) of the update files or update packages.

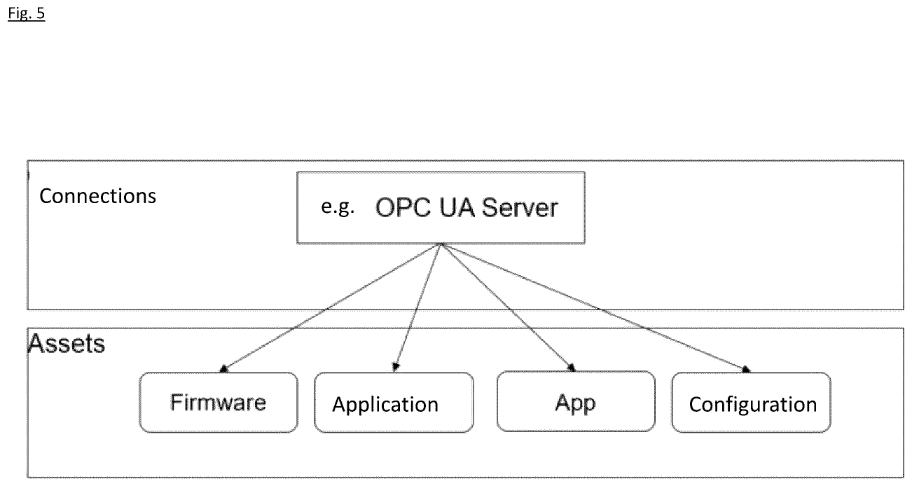

By means of the interface selection and connection service provided via the device management and update user unit 110 set up by programming, the functions of setting up and managing communication interfaces to the automation devices can also be managed appropriately by the DaUM system set up as an intermediate component, so to speak. FIG. 5 shows an exemplary overview of a communication link to an automation device possible by means of the device management and update user unit 110 according to the invention, in the example shown to an OPC UA server of the automation device as communication partner. Such a communication link can thus preferably also connect several assets of the automation device. In the example of a PLC, for example, a corresponding OPC UA server of the PLC can provide the DaUM system with possible connections of this device to included assets, such as firmware, application program, other APP, licenses, configurations, etc.

The device management and update user unit 110 is thus preferably set up by programming to save read-out device type information in each case assigned to an asset specified thereby and comprised by the automation device, in particular relating to firmware, application or configuration of the automation device, for planning the update requests in each case for the assets specified by the saved device type information and to check the retrieved update file in each case with respect to the assets specified by the saved device type information and then to assign released update files to the respective assets.

A communication link, hereinafter also referred to as a connection, describes in particular the connection to an asset of an automation device to be updated, such as firmware, an application, application software (app) or a specific configuration.

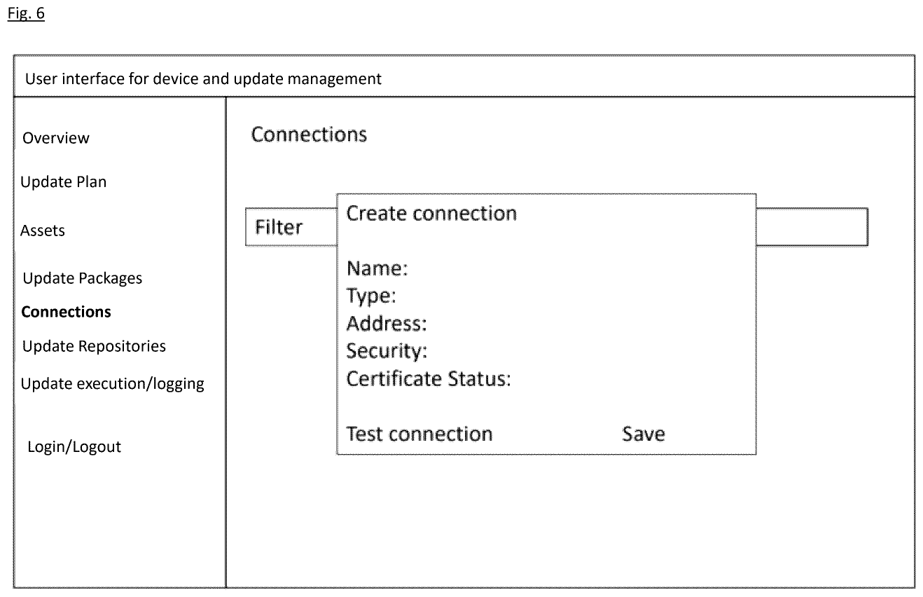

FIG. 6 shows an exemplary user interface as shown in FIG. 2 with an operating screen open for specifying communication interfaces and communication links, via which such connections can be set up through which the respective devices can be reached and managed with the DaUM system.

The connection to a communication partner can therefore be set individually under the menu item links or connections (see FIG. 6). As already mentioned above, this can be an OPC UA server, for example, which then represents at least one asset. However, other connection types, such as SNMP (“Simple Network Management Protocol”), HawkBit (an open platform solution of a framework to integrate the functionality of a “software update” into an IoT (“Internet of Things”) solution or platform),.etc. and/or links to other communication partners can thus be set up appropriately within the scope of the invention. Consequently, the device management and update user unit 110 is thus set up in particular so that different protocols from a plurality of data exchange protocols, in particular comprising standardized protocols, such as OPC UA, SNMP or DCP, and/or open source protocols, can be used within the scope of the invention depending on the automation devices and/or for operating the update file retrieval service.

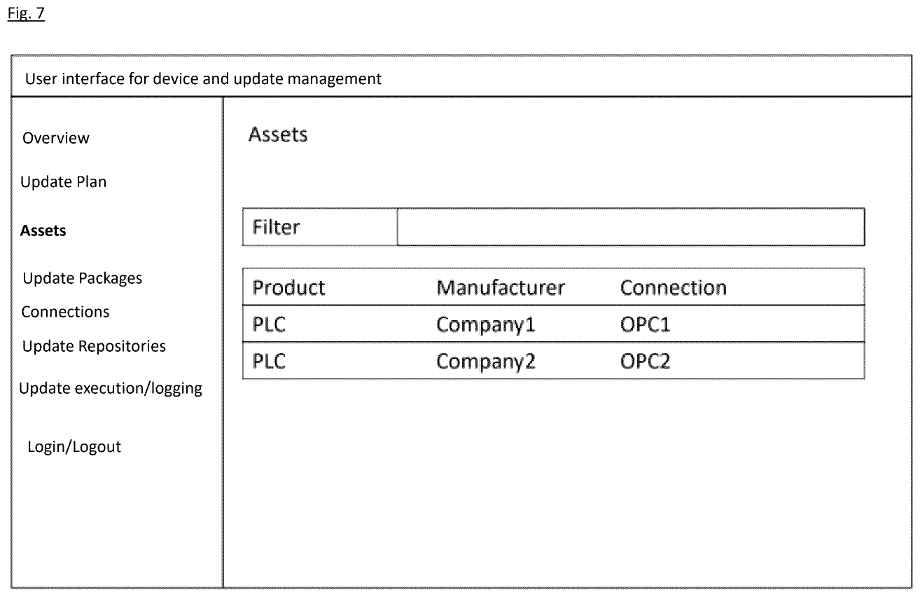

The current status of the link is also conveniently displayed in the menu item links or connections and it is possible to scan for assets within the connections. The assets found can then be displayed in the overview in the Assets menu item with further information (see FIG. 7). The assets can then preferably also be edited here, e.g. tags can be assigned to the individual assets, i.e. the assets are labeled with additional information, whereupon these assets are then available in the further course when creating update plans. The DaUM system can therefore recognize the current status of a respective asset, e.g. the software/firmware, and in particular suggest an update to a newer version to the user/operator or alternatively activate an update independently if there is a new, in particular released version for the asset.

As for the update planning service for planning update requests for each automation device of the plurality of automation devices for which read-out device type information is stored, provided via the device management and update user unit 110 established by programming, files can thus be conveniently also assigned to specific assets, and abort conditions, start times can be set.

The DaUM system, which is set up as an intermediate component, so to speak, can therefore be used to create not just one but also several actualization or update plans for the DaUM service, including for a specific asset. These plans contain the assets to be updated as well as the corresponding actualization files or update packages (see FIG. 8, 9).

The user/operator can therefore also specify an essentially arbitrary time in the future at which the update plan should start or start the update immediately or leave the planning to the DaUM system for independent activation of updates. It is, however, useful that an update plan must first be released by an authorized user.

The individual components (assets) of the automation devices to be updated can be selected accordingly and preferably also automation devices and assets of different types can be combined in an update plan. For example, the order of the assets in the update plan, i.e. the time sequence of checks and/or updates to be carried out in relation to the individual assets, can also be changed and/or all suitable update packages that are available on the DaUM system for the update service can be displayed to the user/operator so that specific update packages required for an update can be selected flexibly.

As already shown above, the user/operator is also given the option of defining the termination behavior for an update plan. The abort behavior determines, for example, how the DaUM system should react in cases where the update of an asset fails. It is therefore also possible to define the termination strategy for all assets in the plan and/or different strategies for different assets.
For example, it can be individually planned to stop the update plan and leave all assets in their current state (“stop and abort all”), i.e. assets that have already been updated retain the update and assets that have not yet been updated are no longer updated.
For example, there may be individually planned to stop the update plan and to additionally perform a version rollback for all devices that have already been updated by the plan (“stop and rollback all”).
For example, it may be individually planned to skip failed devices individually by leaving them as they are and continuing the update with the next device (“skip and proceed”).
For example, it can be individually planned that only the failed devices are rolled back, i.e. reset to the previous version, and the update plan is otherwise continued (“rollback and proceed”). However, if a rollback fails, the device can also be skipped with the documented error status, for example.

By default, the update plans created are independent of each other and are processed sequentially. However, it is also possible, for example, to execute several plans simultaneously in parallel. In this case, it is advantageous to set up the DaUM system to check whether the identical assets are in the plans and to prevent access to the same asset, in particular to inform the user/operator of this event. In the case of plans executed in parallel, it is also possible to specify whether there should be a dependency between the individual plans, in particular by the user/operator. For example, depending on the (partial) failure or success of one or more updates in a first plan, e.g. in a plan A, a second plan executed in parallel, e.g. plan B, can be executed/stopped completely or only partially.

These termination strategies can essentially be designed in the same way as the termination strategies for the individual assets. Consequently, the progress of the updates as well as the results of the updates within the dependency relationships can also be displayed to the user/operator in an appropriate manner. However, the system can also be set up in such a way that the plans are executed one after the other, but dependent on each other. In this case, a plan starts as soon as, or only when, the previous plan has ended. The termination strategy can also be selected or set here. These termination strategies can in turn be essentially the same as the termination strategies of the assets. For example, depending on the (partial) failure or success of one or more updates in a first plan, e.g. in plan A, a subsequent second plan, e.g. plan B, is executed in full or only partially. The progress of the updates as well as the results of the updates within the dependency relationships are conveniently displayed to the user.

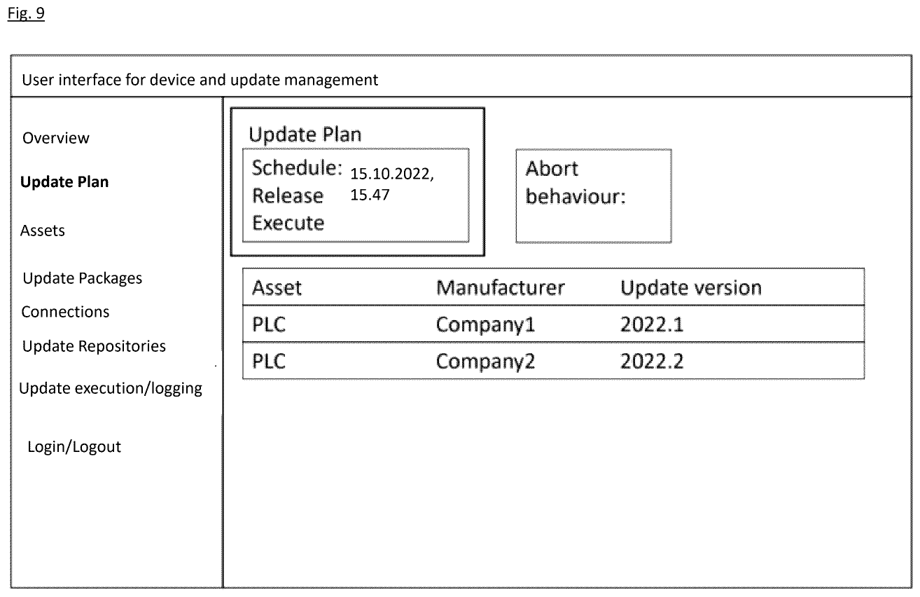

With regard to the update service provided via the device management and update user unit 110 set up by programming, i.e. with regard to the function of carrying out updates on the automation devices, a time in the future can also be appropriately defined at which the update plan is to start or the update is to start immediately (see FIG. 9). Preferably, however, an update plan must be released by an authorized user.

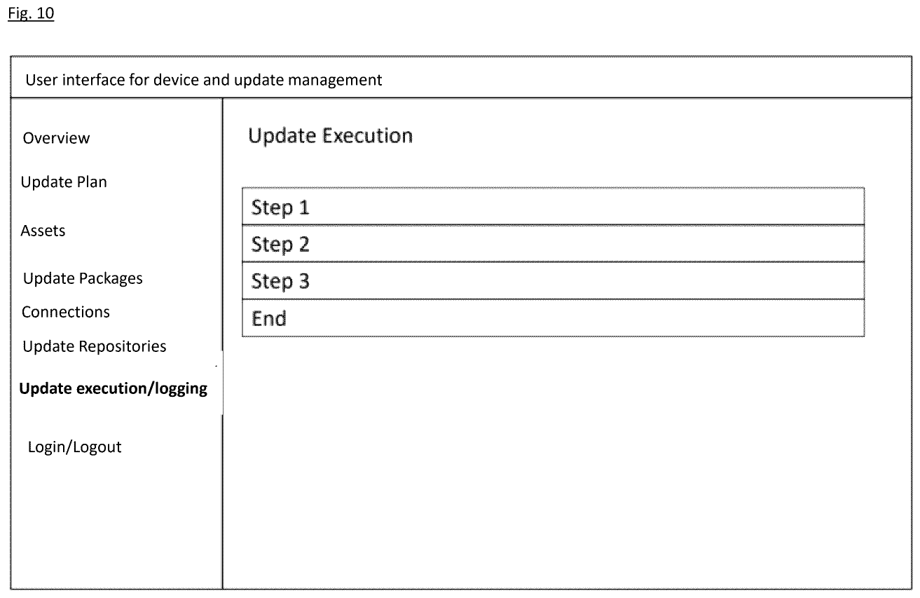

As soon as the update process begins, the update file is transferred to the automation device according to the sequence and a corresponding update command is sent. As soon as an automation device, in particular a specified asset included in the automation device, has been successfully updated, this is appropriately logged and the process continues with the next device (see also FIG. 10).

With regard to the function of logging events, all steps and, in particular, events that take place during the processing of an update plan are preferably recorded in the form of a log book. The user can then be shown the status of the individual assets before and after the update has been carried out.

It is advantageous that the device management and update user unit 110 can be programmed on an edge PC, on one of the plurality of automation devices themselves or on a central server instance of the user. For example, a data storage medium with a program code stored on it and designed in such a way that a data processing device that can be connected to an OT network, if it is programmed with the program code, provides a device management and update user unit set up as described above.

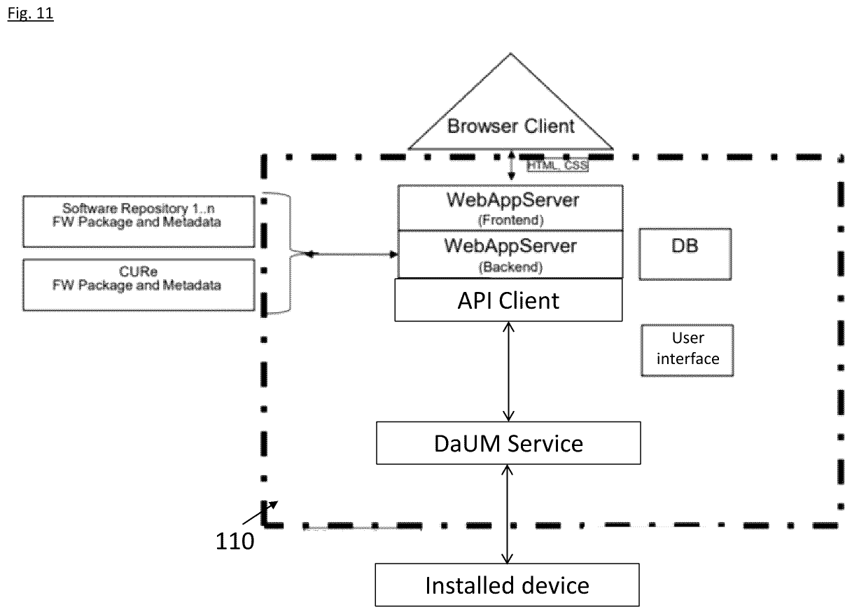

For example, the entire DaUM system (see e.g. also FIG. 11) can also be provided as a reloadable function. This service is preferably offered as a containerized software (Docker) and can thus be conveniently operated on various device classes, e.g. on all device classes of the applicant's PLCnext product line. An application on industrial computers as well as the application on a local PLC can thus be realized.

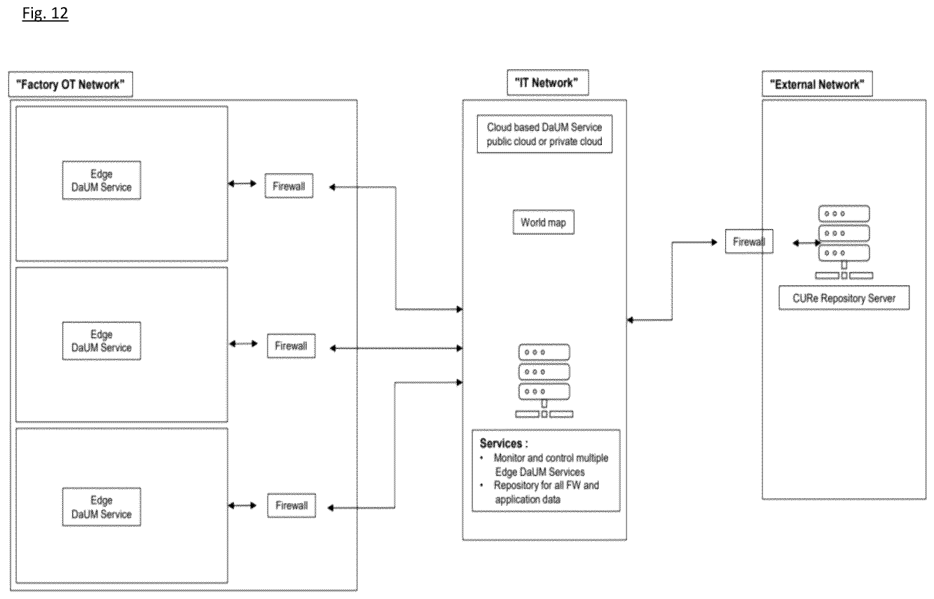

Another advantage is that the DaUM system according to the invention can also be used to provide a superimposed management level of many local DaUM services. Thus, for this purpose, a management platform is expediently included which is hierarchically superimposed on a plurality of device management and update user units described above (cf. e.g. FIG. 12) and is set up to provide update files which are stored in a storage device for retrieval by the plurality of device management and update user units.

As a further possibility, a solution can be implemented with which the management of many local DaUM services is carried out by means of a superimposed management, in particular with a management platform arranged in an IT network, in particular with a management level set up as a cloud-based platform. This management level offers the possibility for the automation devices, and the assets included therein, that are connected to a local DaUM service of centrally retrieving device information from anywhere. For example, the storage device can also be located in another external network connected to the IT network (see FIG. 12).

A major advantage of this superimposed management level is that the respective automation plant or OT network no longer has to be inspected and checked on site to assess the current status of the plant. A glance at the superimposed management level is usually sufficient. Every status message from every hardware device can be translated into plain text there, so that expert knowledge is no longer required to understand them. In addition, the superimposed management level makes it possible to keep the device firmware up to date, ensuring that the devices are always provided with the latest security patches and performance improvements. Furthermore, the functions of the local DaUM services can be used via the superimposed management level. This superimposed management level thus obtains the update packages from the corresponding manufacturer of the automation device to be updated via the Internet, for example, and distributes them to the connected DaUM services. These local DaUM services then distribute the update files locally to the connected assets. This means that only the DaUM service needs to have a connection to the management level, not each individual automation device or even asset.

The positions of the individual local DaUM services can be conveniently displayed in an overview map. When selecting a local DaUM service, the user accesses the information of the automation device and/or asset connected to the DaUM service and can manage the DaUM service and the automation devices and/or assets.

In practical terms, this superimposed management level also makes it possible to update the distributed DaUM services themselves if there are new versions of the DaUM service. This means that not only the automation devices and/or assets can be managed, but the entire system can be monitored and updated from a central location.

This management level can therefore be operated in a private cloud environment or in a user's IT service, for example. For this purpose, everything required to operate the service is preferably supplied in a “container”. The user only needs to provide container management.

A possible implementation scenario with regard to the management and updating of automation devices of an automation system connected to an OT network using the management and updating system according to the invention can be, for example, as follows:

The data required for the update is either retrieved automatically via an https-based connection from a repository operated by a manufacturer, e.g. the applicant, or can be stored locally on the DaUM system via a USB stick (local repository). This data consists of the update file itself as well as the changenotes, license information and a description file with meta information. The description file is coded in JSON (“JavaScript Object Notation”), for example, and contains information about the assets to which the update can be applied. As is well known, version information is traditionally a prerequisite for the update. When the data is read in, it is checked and displayed to the user.

Before an update can be carried out on one or more assets by the update planner, the corresponding file for the update is released by an authorized person with the corresponding role in the DaUM system. As long as an update package has not been released, it can only be used by authorized persons. This may be explicitly desired in order to use the update package for test purposes in a protected area. In order to add further, user-specific information to the update packages, the user/operator can add so-called tags, for example. Based on these tags, the user/operator can filter the desired update packages in the further process.

The devices and/or assets to be managed are reached via various communication channels. The user must configure the communication interface for this. For connections via OPC UA, an OPC UA server of the automation devices must be configured. For distributing software to devices via Hawkbit, a Hawkbit server must be parameterized.

The accessible automation devices/assets are displayed in the DaUM system with their version information. This information is freely selectable and can include, for example, information on the installation location, machine number, etc. The user can use these tags to filter the desired automation devices/assets in the further process.

Based on the status of the update files and the accessible devices, a user with authorization can schedule an update. For this he selects the automation devices/assets to be updated from a list of accessible automation devices/assets. The selected ones are transferred to the plan and the current version status is displayed. Depending on which version of the software/firmware is available on the automation devices/assets, possible update files are suggested. This check does not take place on the end devices, but in the DaUM system. The user selects the files to be used for the automation devices/assets and sets a time at which the update should begin. The user can also define when an update plan should be canceled. The following conditions apply here, for example:
Stop and cancel all—this leaves all assets in their current state;
Stop and rollback—performs a version rollback on all assets that have already been updated by the plan;
Skip and continue—skips the failed asset by leaving it as it is and continues the update with the next asset;
Rollback and continue—only the failed asset is undone and the plan is continued. At the end of the planning process, the plan must be released so that it can be executed. Otherwise it is only saved.

As soon as the time for a released plan has been reached or the user has started the plan manually, the DaUM system begins to distribute the update packages to the automation devices/assets and initiate the update. After downloading the files to an automation device/asset, the system also checks whether the file has arrived unchanged and, depending on whether the status of the automation device/asset allows an update, the update is then carried out. A successful or unsuccessful update is reported back to the DaUM system. If an update of an automation device/asset fails, the plan is continued according to the selected termination condition. All processes in the DaUM system are logged with a time stamp and user details and are available in the DaUM system.

In summary, it can therefore be stated that the management and updating system, “DaUM system”, designed according to the invention enables manufacturer-independent management and updating of automation devices connected to an OT network by means of a device management and updating user unit set up quasi as an intermediate component and likewise connected to the OT network. To set up such a device management and update user unit, a program code stored on a data storage medium can be used for the corresponding programming of a data processing device that can be connected to the OT network.

As shown above, these automation devices can be, for example, programmable logic controllers (PLCs), IO modules, frequency converters, robots, network devices, power supplies and/or other components used in automation technology. It is also advantageous that the system according to the invention can use standardized protocols, i.e. in particular protocols based on OPC UA (“Open Platform Communications Unified Architecture”; a standard for data exchange as a platform-independent, service-oriented architecture), SNMP (“Simple Network Management Protocol”, a network protocol developed by the IETF to monitor and control network elements from a central station) or DCP (“Dynamic Code Programming”, a dynamization of object-oriented programming or service-oriented architecture), whereby software can also be distributed to devices, e.g. using an Eclipse Hawkbit client (open source solution from the Eclipse Foundation). In addition to the possibility of updating many different components of the automation devices of an automation plant, the necessary security, in particular the application-related security (in English Security), can also be consistently ensured at all levels. In preferred embodiments, it can be ensured that all communication, in particular including the necessary commands and instructions, can only be carried out authenticated and authorized. In particular, the requirements of the international standard IEC 62443, which defines both technical and procedural aspects of industrial cybersecurity, can be met. It is well known that the relevant requirements for the cybersecurity of machines and systems have increased massively in recent years. If older automation devices are present in the automation plant, which may not be able to meet the security properties of the management and update system within the scope of the invention, they can, for example, also be supplied with new software modules and/or marked separately so that, for example, possible security risks are stored in a log and can be retrieved if required. In addition, the device management and updating user unit can be operated at a wide variety of levels, such as on an edge PC in the automation plant, on a central server instance of the user or even on an automation device of the automation plant itself, i.e. depending in particular on the application and size of the management and updating system.

1. A management and updating system for automation devices connected to an OT network of an automation plant, comprising:
a device management and update user unit connected to an OT network to which a plurality of automation devices of an automation plant are further connected, wherein the device management and update user unit is further set up by programming to provide:
an interface selection and connection service set up to select and set up a communication interface for establishing a communication link to an automation device of the plurality of connected automation devices,
a read-out service, set up for activating a read-out from each automation device to which the communication link is established, of device type information stored in the automation device, and for saving the device type information read out in each case,
an update planning service set up to plan update requests for each automation device of the plurality of automation devices for which read-out device type information is saved,
an update file retrieval service set up to establish a communication link to at least one storage device and to retrieve update files saved in the storage device,
a check and allocation service, set up to check each retrieved update file for its release with respect to the plurality of automation devices in functional dependence on the saved device type information and, if the check of one of the retrieved update files results in a release for an automation device, to allocate this update file to the device type information saved for this automation device, and
an update service, set up for transmitting to each automation device the update file allocated to it in each case, including an update command, in accordance with saved device type information, in each case as a functional function of the update requests planned for each automation device.

2. The management and updating system according to claim 1, wherein the device management and update user unit is further set up by programming:
to save the allocate update files, and/or
to log the respective update status with respect to each automation device for which read-out device type information is saved.

3. The management and updating system according to claim 1, wherein the device management and updating user unit is furthermore set up by programming:
for saving the read-out device type information each associated with an asset specified thereby and comprised by the automation device, comprising firmware, application or configuration of the automation device, for planning the update requests each for the assets specified by the saved device type information, for checking the retrieved update file each with respect to the assets specified by the saved device type information, and for allocating the released update files to the respective assets.

4. The management and updating system according to claim 1, wherein the update files for checking each retrieved update file are each retrieved together with description files associated with the stored update files comprising information on the file type, the update file, manufacturer information, version information, type information, dependencies on existing previous versions and/or hardware versions, a unique ID, checksum, release status, and/or information on further accompanying documents comprising license information and/or change notes.

5. The management and updating system according to claim 1, wherein a number of public keys is storable in a memory of the device management and updating user unit, and the verification and allocation service is set up, using the number of public keys, to verify signatures created with a private key contained in the retrieved update files, respectively.

6. The management and updating system according to claim 1, wherein the device management and updating user unit is set up by programming on an edge PC, on one of the plurality of automation devices itself or on a central server instance of the user.

7. The management and updating system according to claim 1, wherein the device management and update user unit is further set up to use different protocols from a plurality of data exchange protocols comprising standardized protocols, such as OPC UA, SNMP or DCP, and/or open source protocols, depending on the automation devices and/or for operating the update file retrieval service.

8. The management and updating system according to claim 1, further comprising a management platform hierarchically superimposed on a plurality of device management and updating user units according to any one of the preceding claims and set up to provide update files stored in a storage device for retrieval by the plurality of device management and updating user units.

9. The management and updating system according to claim 1, wherein further the management platform is arranged in an IT network comprising a cloud-based platform.

10. A data storage medium having a program code stored thereon, the program code being such that a data processing device connectable to an OT network, when programmed with the program code, provides a device management and updating user unit set up in accordance with claim 1.
